(19) United States
(12) Patent Application Publication
(10) Pub. No.: US 2019/0220520 A1
(43) Pub. Date: Jul. 18, 2019

(54) SIMULTANEOUS INTERPRETATION SYSTEM, SERVER SYSTEM, SIMULTANEOUS INTERPRETATION DEVICE, SIMULTANEOUS INTERPRETATION METHOD, AND COMPUTER-READABLE RECORDING MEDIUM

(71) Applicant: CHIH HUNG KAO, Taipei City (TW)

(72) Inventor: CHIH HUNG KAO, Taipei City (TW)

(21) Appl. No.: 15/871,992

(22) Filed: Jan. 16, 2018

(51) Int. Cl. G06F 17/28; G10L 15/26; G10L 15/22

(52) U.S. Cl. CPC G06F 17/289; H04W 88/02; G10L 15/22; G10L 15/265

(57) ABSTRACT

The present invention is to provide a simultaneous interpretation method, comprising the steps of: acquiring an audio stream data input by a user into a simultaneous interpretation device; converting the audio stream data into textual data according to a source language, after acquiring the audio stream data; translating the textual data according to text corpuses in an optimized database that correspond to a target language in order to acquire a first translation text; transmitting the textual data to a third-party database in order for the third-party database to translate the textual data according to the target language, and acquiring a second translation text from the third-party database; and determining whether the first translation text is acquired; and if yes, converting the first translation text into an audio stream data and transmitting the audio stream data to the simultaneous interpretation device in order for the simultaneous interpretation device to output the audio stream data in voice; or if no, converting the second translation text into an audio stream data and transmitting the audio stream data to the simultaneous interpretation device in order for the simultaneous interpretation device to output the audio stream data in voice.

### BACKGROUND OF THE INVENTION

### 1. Technical Field

The present invention relates to a simultaneous interpretation system, a server system, a simultaneous interpretation device, a simultaneous interpretation method, and a computer-readable recording medium and more particularly to a simultaneous interpretation system, a server system, a simultaneous interpretation device, a simultaneous interpretation method, and a computer-readable recording medium that have expandability of translation database by a user.

### 2. Description of Related Art

With the development of globalization and the growing ease of transportation, distances between different parts of the world seem to have reduced, providing people with more opportunities to work or travel abroad. Recently, the number of foreign tourists in Taiwan is also on the rise, indicating a trend of internationalization not only in commerce but also in tourism.

When people of different nationalities try to communicate with one another, language can always be a problem. In order for tourists in a foreign land not to suffer from poor communication with the locals due to idiomatic differences, the market has been supplied with a good number of simultaneous translation devices and translation software that provide simultaneous translation to facilitate two-way communication. Such devices tend to increase the resolution of translation as much as possible so that erroneous translation, and hence misunderstanding between the two parties of a dialog, can be prevented. However, raising the standard of translation resolution may hinder the texts in a database from forming the desired translation, and a translation device in this situation may become irresponsive and therefore fail to translate what is needed at the moment.

### BRIEF SUMMARY OF THE INVENTION

The primary objective of the present invention is to solve the prior art problem that an increase in the translation resolution of a conventional translation device may prevent the texts in a database from forming the desired translation.

To achieve the objective, the present invention provide a server system, comprising: a server connected to at least one mobile device through a communication network, wherein the mobile device is paired with at least one simultaneous interpretation device, respectively, and the server is loaded with a program and executing modules comprises: a communication module for acquiring, through the communication network, textual data generated by the mobile device from a user; a first translation module for translating the textual data according to text corpuses in an optimized database that correspond to a target language and thereby acquiring a first translation text; a second translation module for transmitting the textual data to a third-party database in order for the third-party database to translate the textual data according to the target language and acquiring a second translation text from the third-party database; and a translation result output module for, upon acquiring the first translation text, transmitting the first translation text to the mobile device in order for the simultaneous interpretation device to output the first translation text in voice; and upon failure to acquire the first translation text, transmitting the second translation text to the mobile device in order for the simultaneous interpretation device to output the second translation text in voice.

Further, the translation result output module creates a correlated text corpus index entry and a translation text according to the textual data and the second translation text upon failure to acquire the first translation text, and storages the correlated text corpus index entry and the translation text into the optimized database.

Another objective of the present invention is to provide a simultaneous interpretation device for use with the server system and the mobile device as foresaid, the simultaneous interpretation device comprising: an audio input unit for receiving a user's voice; a wireless transmission unit coupled to the user's said mobile device by wireless transmission way; an audio output unit for outputting audio signals; and a processor connected to the audio input unit, the audio output unit, and the wireless transmission unit, wherein the processor acquires the user's said voice from the audio input unit, converts the voice into an audio stream data, and transmits the audio stream data to the mobile device by wireless transmission way, in order for the mobile device to transmit the audio stream data to the server system through a said communication network accessible to the mobile device, and to receive an audio stream data converted according to the first translation text or the second translation text acquired by the server system in order to be output in voice.

Further, the wireless transmission unit is a Bluetooth module.

Further, the wireless transmission unit comprises a command transmission module and an audio transmission module, and the processor transmits control instructions to the mobile device through the command transmission module via a command channel and receives the audio stream data from the mobile device through the audio transmission module via an audio streaming channel.

Further, the command transmission module transmits control instructions to the mobile device through a Bluetooth Low Energy (BLE) channel or Serial Port Profile (SPP) channel, and the audio transmission module receives the audio stream data from the mobile device through an Advanced Audio Distribution Profile (A2DP) channel.

Further, the simultaneous interpretation device further comprises a first language trigger unit and a second language trigger unit, wherein the processor transmits to the mobile device a recorded audio stream data as well as a first command corresponding to a first target language upon detecting activation of the first language trigger unit, and transmits to the mobile device a recorded audio stream data as well as a second command corresponding to a second target language upon detecting activation of the second language trigger unit, in order for the server to convert the recorded audio stream data into textual data in a corresponding one of the first target language and the second target language according to the corresponding one of the first target language and the second target language.

Another objective of the present invention is to provide a simultaneous interpretation system, comprising: a simultaneous interpretation device; a mobile device connected to the simultaneous interpretation device by wireless transmission way; and a server connected to the mobile device through a communication network; wherein the simultaneous interpretation device transmits an audio stream data to the mobile device by wireless transmission way, the mobile device converts the audio stream data into textual data and transmits the textual data to the server through the communication network, the server translates the textual data according to a target language and text corpuses in an optimized database to acquire a first translation text, the server also transmits the textual data to a third-party database in order for the third-party database to translate the textual data and for the server to acquire a second translation text from the third-party database, and the server transmits the first translation text to the mobile device upon acquiring the first translation text, in order for the simultaneous interpretation device to output the first translation text in voice, or transmits the second translation text to the mobile device upon failure to acquire the first translation text, in order for the simultaneous interpretation device to output the second translation text in voice.

Further, the server creates a correlated text corpus index entry and a translation text according to the textual data and the second translation text upon failure to acquire the first translation text, and storages the correlated text corpus index entry and the translation text into the optimized database.

Further, when disconnected from the server, the mobile device converts the audio stream data into the textual data according to an offline database downloaded and thereby established from the server by a user in advance, to translate the textual data according to text corpuses in the offline database that correspond to the target language and thereby acquire a third translation text, to convert the third translation text into an audio stream data, and to transmit the audio stream data to the simultaneous interpretation device in order for the simultaneous interpretation device to output the audio stream data in voice.

Another objective of the present invention is to provide a simultaneous interpretation method, comprising the steps of: acquiring an audio stream data input by a user into a simultaneous interpretation device; converting the audio stream data into textual data according to a source language, after acquiring the audio stream data; translating the textual data according to text corpuses in an optimized database that correspond to a target language in order to acquire a first translation text; transmitting the textual data to a third-party database in order for the third-party database to translate the textual data according to the target language, and acquiring a second translation text from the third-party database; and determining whether the first translation text is acquired; and if yes, converting the first translation text into an audio stream data and transmitting the audio stream data to the simultaneous interpretation device in order for the simultaneous interpretation device to output the audio stream data in voice; or if no, converting the second translation text into an audio stream data and transmitting the audio stream data to the simultaneous interpretation device in order for the simultaneous interpretation device to output the audio stream data in voice.

Further, the simultaneous interpretation method creates a correlated text corpus index entry and a translation text according to the textual data and the second translation text upon failure to acquire the first translation text, and storages the correlated text corpus index entry and the translation text into the optimized database.

Another objective of the present invention is to provide a non-transient computer-readable recording medium, including programs that are able to execute the foresaid simultaneous interpretation method by a computer.

The present invention has the following advantages over the prior art:

1. According to the present invention, translation is carried out by a third-party database whenever the optimized database is unable to produce a correct translation. This ensures that the user will always be provided with a translation result.

2. According to the present invention, a third-party database can optimize the optimized database by increasing the amount of big data in the optimized database.

### BRIEF DESCRIPTION OF THE DRAWINGS

FIG. 1 shows a block schematic diagram of a simultaneous interpretation system of the present invention.

FIG. 2 shows a block schematic diagram of a simultaneous interpretation device of the present invention.

FIG. 3 shows a block schematic diagram of a server system of the present invention.

FIG. 4 shows a flow schematic diagram of a simultaneous interpretation method of the present invention.

### DETAILED DESCRIPTION OF THE INVENTION

A detailed description and the technical contents of the present invention are given below with reference to the accompanying drawings.

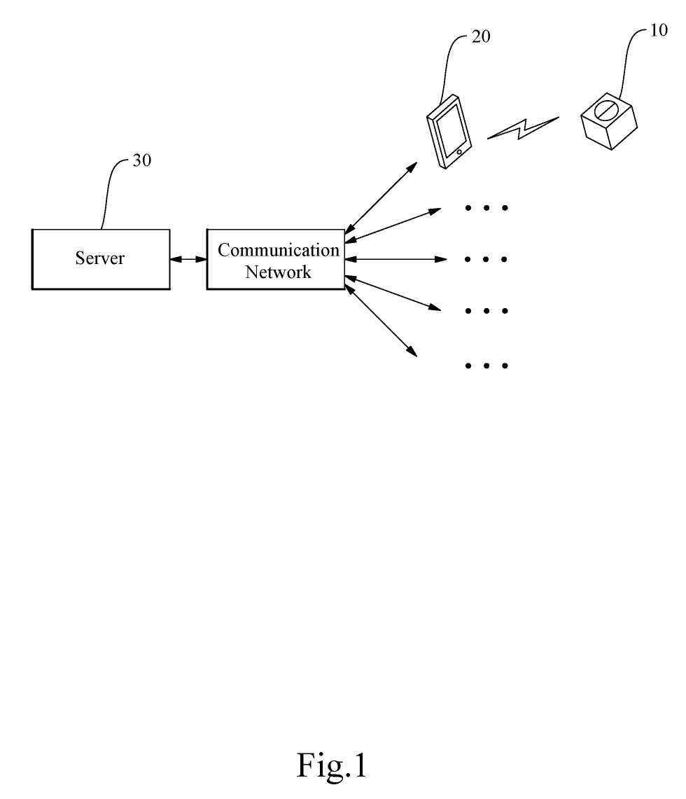

Referring to FIG. 1, the simultaneous interpretation system of the present invention essentially includes a simultaneous interpretation device 10, a mobile device 20 connected to the simultaneous interpretation device 10 by wireless transmission, and a server 30 connected to the mobile device 20 through a communication network. The simultaneous interpretation device 10 and the mobile device 20 are at a user end. The server 30 is so configured that mobile devices 20 at a plurality of user ends can connect remotely to the server 30 via communication networks respectively accessible to the mobile devices 20.

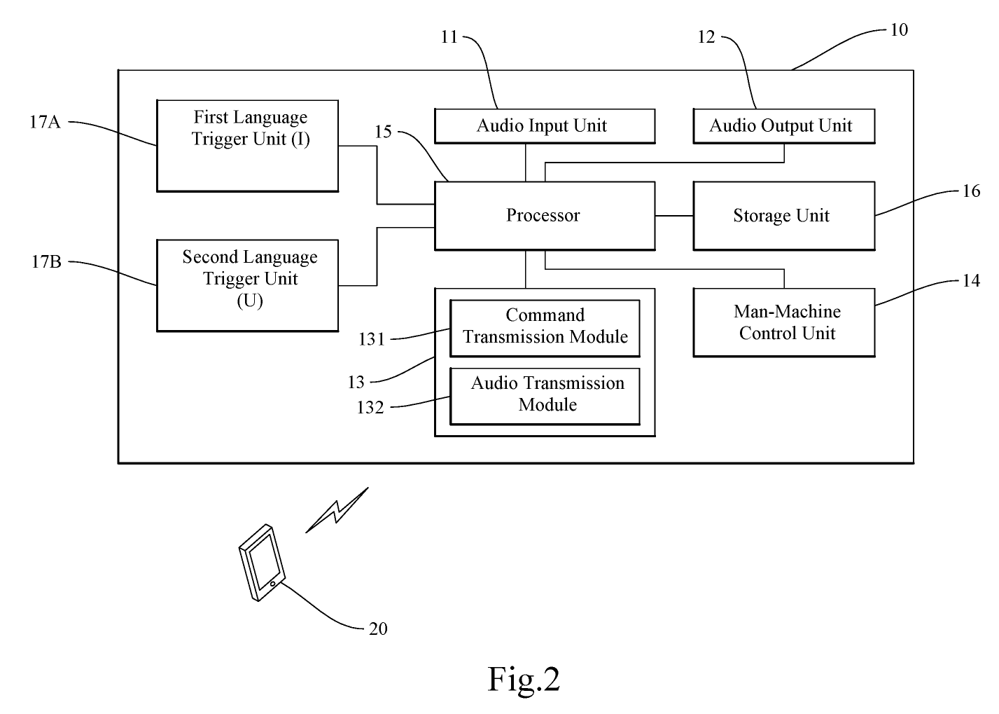

Referring to FIG. 2, the simultaneous interpretation device 10 is connected to the mobile device 20 by wireless transmission in order to communicate with the server 30 through the communication network accessible to the mobile device 20. The mobile device 20 includes an application program (APP) that enables one- or two-way operation between the mobile device 20 and the simultaneous interpretation device 10. The mobile device 20 may be a mobile phone, a tablet computer, a laptop computer, or a similar electronic device; the present invention has no limitation in this regard.

The simultaneous interpretation device 10 includes an audio input unit 11, an audio output unit 12, a wireless transmission unit 13, a man-machine control unit 14, a processor 15 connected to each of the above, and a storage unit 16.

The audio input unit 11 is configured for receiving a user-input voice message. More specifically, the audio input unit 11 may be a microphone. The audio output unit 12 is configured for outputting audio signals. More specifically, the audio output unit 12 may be a loudspeaker. The wireless transmission unit 13 is coupled to the user's mobile device 20 by wireless transmission so that one- or two-way operation between the simultaneous interpretation device 10 and the mobile device 20 can be conducted. More specifically, the wireless transmission unit 13 may be a Bluetooth module or a WiFi module. The man-machine control unit 14 may be an output unit and/or an input unit through which the user can verify the working state of the simultaneous interpretation device 10 or input corresponding control instructions. More specifically, the man-machine control unit 14 may, as an output unit, be an indicator light, a display, or a loudspeaker and/or, as an input unit, be a press-key, a keyboard, or a touch panel; the present invention has no limitation on the type of the man-machine control unit 14.

The processor 15 is connected to the storage unit 16 and is configured for accessing and executing programs in the storage unit 16. For example, the processor 15 may be a central processing unit (CPU), a programmable general- or special-purpose microprocessor, a digital signal processor (DSP), a programmable controller, an application-specific integrated circuit (ASIC), a programmable logic device (PLD), or the like or a combination of the above. In another preferred embodiment, the processor 15 and the storage unit 16 are integrally formed as a single processor. The present invention has no limitation on the type or configuration of the processor 15.

The processor 15 is configured for loading programs from the storage unit 16, inputting and outputting commands, receiving and transmitting audio stream data, and coordinating the working states of the various elements of the simultaneous interpretation device 10.

In a preferred embodiment, the wireless transmission unit 13 is a Bluetooth module, and in order to achieve uninterrupted audio stream dataing during two-way communication, the wireless transmission unit 13 includes a command transmission module 131 and an audio transmission module 132. The processor 15 transmits control instructions to the mobile device 20 through the command transmission module 131 via a command channel and transmits audio stream data to, and receives audio stream data from, the mobile device 20 through the audio transmission module 132 via an audio streaming channel. In a preferred embodiment, the command channel is a Bluetooth Low Energy (BLE) or Serial Port Profile (SPP) channel, and the audio streaming channel is an Advanced Audio Distribution Profile (A2DP) channel.

The mobile device 20 is installed with a mobile application program so as to work in conjunction with the simultaneous interpretation device 10. More specifically, the mobile application program can connect the mobile device 20 to the simultaneous interpretation device 10 through a Bluetooth module (or WiFi module) in order for the mobile device 20 to receive commands from and transmit commands to the simultaneous interpretation device 10 and to transmit audio stream data. The mobile device 20 can also connect to the server 30 via a communication network (e.g., a GSM, GPRS, 3G, or 4G mobile communication network or a WiFi network) so that, even when away from the server 30, the user can connect the mobile device 20 remotely to the server 30 in order for simultaneous translation to be carried out.

In a preferred embodiment, the mobile application program provides an operation interface for use by the user. Such operation interfaces may include, for example, interfaces for editing the translation of a phrase or sentence, for downloading an offline translation package, for connecting to a translation-related social networking website, for switching or setting translation language pairs (each pair including a source language and a target language), and switching on/off a Bluetooth loudspeaker; the present invention has no limitation in this respect.

To facilitate translation, and according to settings made in advance, the simultaneous interpretation device 10 may provide an operation interface for switching input languages rapidly so that, when having a dialog with someone, the user can readily switch between two langue modes. More specifically, the simultaneous interpretation device 10 may include a first language trigger unit 17A (referred to herein as “I”) for translating common expressions in the user's language into the langue of the other party (referred to herein as the second party) of the dialog and a second language trigger unit 17B (referred to herein as “U”) for translating common expressions in the second party's language into the user's langue. When detecting that the first language trigger unit 17A is triggered, the processor 15 transmits a recorded audio stream data and a first command corresponding to a first source language and a first target language to the mobile device 20, in order for the mobile device 20 to translate the recorded audio stream data into textual data according to the first source language. When detecting that the second language trigger unit 17B is triggered, the processor 15 transmits a recorded audio stream data and a second command corresponding to a second source language and a second target language to the mobile device 20, in order for the mobile device 20 to translate this recorded audio stream data into textual data according to the second source language. The textual data thus obtained is transmitted to the server 30 in order to be translated by the server 30 according to the first target language or the second target language.

As the server 30 must be able to interact with multiple mobile devices 20 at the same time, it is preferable that conversion from an audio stream data to the corresponding textual data is performed by the corresponding mobile device 20 with a view to reducing the load on the server 30. Besides, with each mobile device 20 in charge of such conversion, the textual data to be transmitted from each mobile device 20 to the server 30 is already resolved, which greatly reduces the data flow of each mobile device 20.

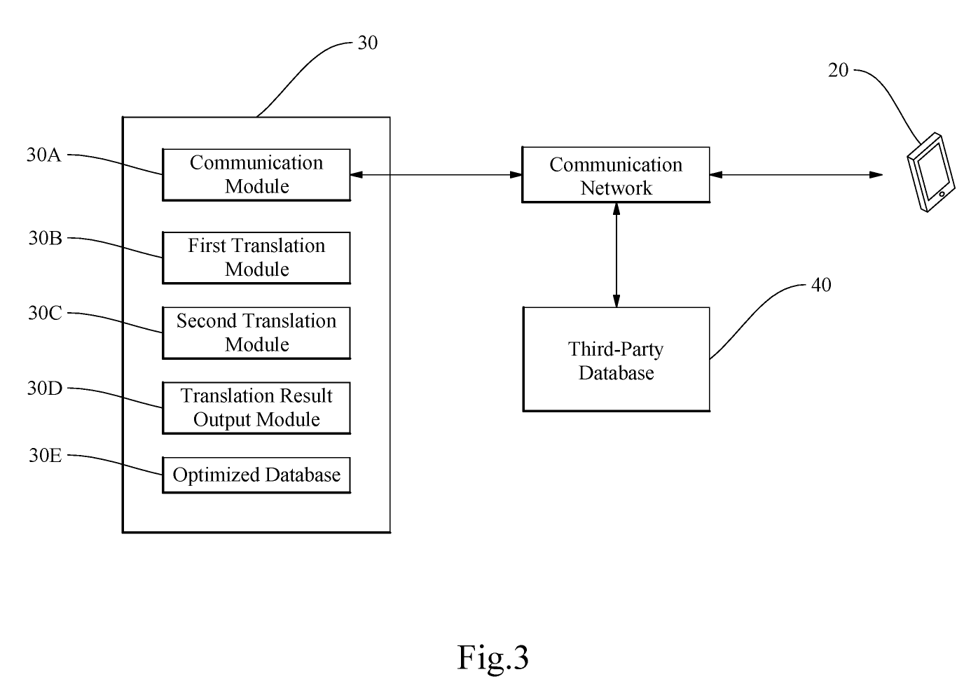

The foregoing server system is so designed that a plurality of users can connect their respective mobile devices 20 to the system for remote translation. Referring to FIG. 3, the server system includes at least one server 30. The server 30 is configured for loading and executing programs and includes a communication module 30A, a first translation module 30B, a second translation module 30C, and a translation result output module 30D.

Through a communication network, the communication module 30A acquires the audio stream data input by a user via the simultaneous interpretation device 10. The communication module 30A can connect to the Internet through a channel provided by a physical or non-physical line, in order to establish remote connection with the mobile devices 20 of a plurality of users, to receive textual data from and transmit textual data to the mobile devices 20, or to provide a platform to enable access or operation by the users' mobile devices 20.

The first translation module 30B is configured for translating the textual data according to the text corpuses in an optimized database 30E that correspond to the target language and thereby acquiring a first translation text. More specifically, an exact or fuzzy search can be conducted during the translation process in order to find the most appropriate comparison result and hence obtain the optimal translation result. In another preferred embodiment, the first translation module 30B determines and outputs the translation result by resolving the textual data into words and analyzing the arrangement of the words while taking into account the parts of speech, grammar, and/or the context in order to optimize the translation result; the present invention has no limitation in this regard.

The optimized database 30E may be provided in the same server 30 as the first translation module 30B or in a separate computer or server connected to the server 30, provided that the first translation module 30B can access the contents of the optimized database 30E in order to output a translation result. The optimized database 30E may have a text corpus index based on its compilation logic, with all the translation texts in the database arranged accordingly, allowing each translation text to be found through correlation to the corresponding entry in the text corpus index. For example, after receiving textual data in a source or target language, a plurality of related translation texts can be found through the text corpus index corresponding to the source or target language. There may be a plurality of corresponding translation texts in different languages such as Chinese, English, Japanese, German, French, and Russian; the present invention has no limitation in this regard.

In a preferred embodiment, the first translation module 30B may fail to acquire a correct translation result based on the set conditions (e.g., when idioms, local usages, and so on in the optimized database 30E are not updated), or the translation result output from the optimized database 30E may be determined as obviously wrong by the first translation module 30B. In either case, the first translation module 30B may choose not to output the first translation text or generate a translation error message instead.

The second translation module 30C is configured for translating the textual data according to the text corpuses in a third-party database 40 that correspond to the target language and thereby acquiring a second translation text. More specifically, the second translation module 30C can obtain a translation result from the third-party database 40 after being granted authority to do so. The third-party database 40 (e.g., Google Translate or WorldLingo) provides an application interface (API) through which to input the textual data and to output a translation in the target language. In a preferred embodiment, the server 30 achieves simultaneous translation by the first translation module 30B translating the textual data to acquire the first translation text and by the second translation module 30C transmitting the same textual data to the third-party database 40 for translation at the same time in order to acquire the second translation text; thus, the time required for online translation is shortened.

The translation result output module 30D is configured for outputting the first translation text or the second translation text to the mobile device 20. More specifically, the translation result output module 30D can make a decision as to whether to output the first or second translation text. When acquiring the first translation text, the translation result output module 30D transmits the first translation text to the mobile device 20 in order for the simultaneous interpretation device 10 to output the first translation text in voice. If the first translation text is not acquired (e.g., due to system timeout or when a translation error message is received), the translation result output module 30D transmits the second translation text to the mobile device 20 in order for the simultaneous interpretation device 10 to output the second translation text in voice.

In a preferred embodiment, the system (server) can expand the contents of the optimized database 30E by learning. More specifically, upon failure to acquire the first translation text, the translation result output module 30D creates a translation text and a correlated text corpus index entry according to the textual data and the second translation text and adds the newly created translation text and text corpus index entry into the optimized database 30E to expand the data in the optimized database 30E. The expanded data can be edited and revised by system maintenance personnel according to the contents of the translation to enhance the contents of the database.

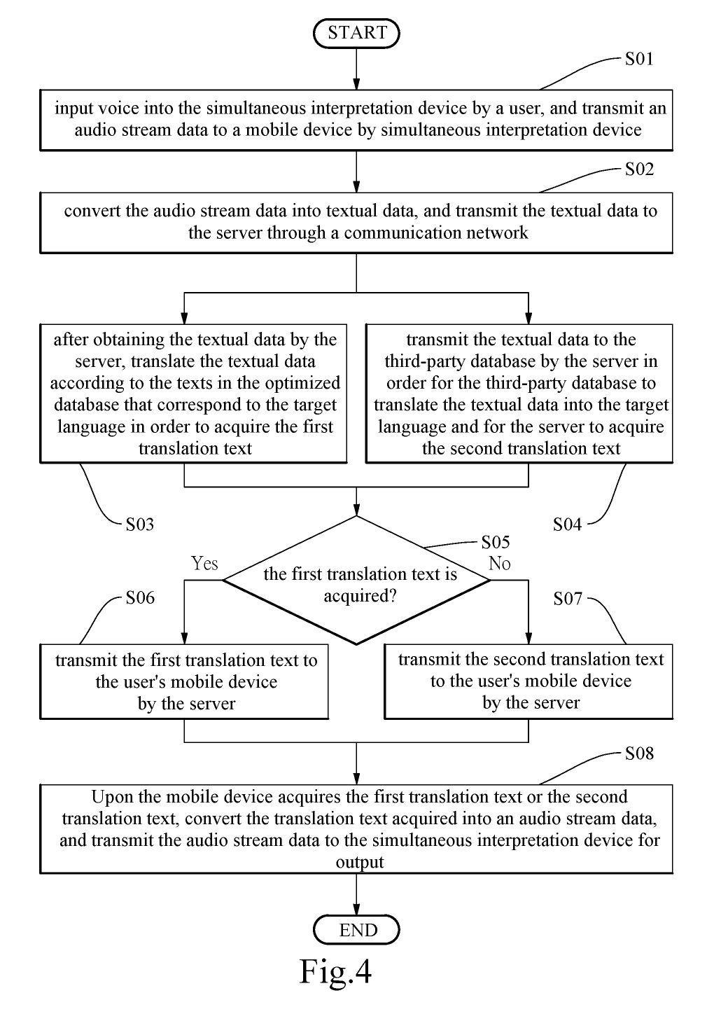

The succeeding paragraphs describe the simultaneous interpretation method of the present invention. Referring to FIG. 4, the simultaneous interpretation method, to be performed by the foregoing simultaneous interpretation system, includes the following steps:

To begin with, a user inputs voice into the simultaneous interpretation device 10, and the simultaneous interpretation device 10 converts the voice received into an audio stream data, which is transmitted by the wireless transmission unit 13 of the simultaneous interpretation device 10 to the mobile device 20 (step S01). While inputting the voice, the user may trigger the first language trigger unit 17A (I) or the second language trigger unit 17B (U) by pressing a press-key, in order for the output signals of the simultaneous interpretation device 10 to include a command that includes the source language and target language corresponding to the first language trigger unit 17A or the second language trigger unit 17B, thereby confirming the language to be translated and the language to be translated to.

After receiving the audio stream data, the mobile device 20 converts it into textual data based on the source language and transmits the textual data to the server 30 through a communication network (step S02). In another embodiment, conversion from the audio stream data to the textual data is conducted by the server 30; that is to say, the mobile device 20 transmits the audio stream data to the server 30, and the server 30 converts the audio stream data into the textual data.

After obtaining the textual data, the server 30 translates it according to the text corpuses in the optimized database 30E that correspond to the target language in order to acquire the first translation text (step S03). At the same time, the server 30 transmits the textual data to the third-party database 40 in order for the third-party database 40 to translate the textual data into the target language and for the server 30 to acquire the second translation text (step S04).

Following that, the sever 30 determines whether it has acquired the first translation text (step S05). If the first translation text is acquired, the server 30 transmits the first translation text to the user's mobile device 20 (step S06); if the first translation text is not acquired, or if a translation error message is obtained, the server 30 transmits the second translation text to the user's mobile device 20 (step S07).

The mobile device 20 acquires the first translation text or the second translation text, converts the translation text acquired into an audio stream data, and transmits the audio stream data to the simultaneous interpretation device 10 for output (step S08). In a preferred embodiment, it is the server 30 that performs the sub-step of converting the first or second translation text into an audio stream data in step S08, and the audio stream data is transmitted by the server 30 to the mobile device 20 via the communication network. The present invention has no limitation on whether the sub-step is performed by the mobile device 20 or the server 30.

In the case where the server 30 fails to acquire the first translation text, the server 30 not only transmits the second translation text, which is translated by the third-party database 40, to the mobile device 20, but also creates a translation text and a correlated text corpus index entry according to the textual data and the second translation text as an addition to the optimized database 30E, wherein the newly added translation text and text corpus index entry can be edited by a system administrator.

The embodiments described above can be implemented via a non-transient computer-readable recording medium that includes computer-executable commands such as computer-executable program modules. The computer-readable recording medium includes any data storage device that can store data to be read by a computer system. For example, the computer-readable recording medium may be a read-only memory (ROM), a random-access memory (RAM), a CD-ROM, a magnetic tape, a floppy disk, an optical data storage device, and/or another suitable medium. The computer-readable recording medium may be distributed in a network-coupled computer system such that computer-readable codes are stored and executed in a distributed manner.

In summary, according to the present invention, translation is carried out by a third-party database whenever the optimized database is unable to produce a correct translation. This ensures that the user will always be provided with a translation result. Furthermore, according to the present invention, a third-party database can optimize the optimized database by increasing the amount of big data in the optimized database.

The present invention is more detailed illustrated by the above preferable example embodiments. While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A server system, comprising:
a server connected to at least one mobile device through a communication network, wherein the mobile device is paired with at least one simultaneous interpretation device, respectively, and the server is loaded with a program and executing modules comprises:
a communication module for acquiring, through the communication network, textual data generated by the mobile device from a user;
a first translation module for translating the textual data according to text corpuses in an optimized database that correspond to a target language and thereby acquiring a first translation text;
a second translation module for transmitting the textual data to a third-party database in order for the third-party database to translate the textual data according to the target language and acquiring a second translation text from the third-party database; and
a translation result output module for, upon acquiring the first translation text, transmitting the first translation text to the mobile device in order for the simultaneous interpretation device to output the first translation text in voice; and upon failure to acquire the first translation text, transmitting the second translation text to the mobile device in order for the simultaneous interpretation device to output the second translation text in voice.

2. The server system of claim 1, wherein the translation result output module creates a correlated text corpus index entry and a translation text according to the textual data and the second translation text upon failure to acquire the first translation text, and storages the correlated text corpus index entry and the translation text into the optimized database.

3. A simultaneous interpretation device for use with the server system and the mobile device in claim 1, the simultaneous interpretation device comprising:
an audio input unit for receiving a user's voice;
a wireless transmission unit coupled to the user's said mobile device by wireless transmission way;
an audio output unit for outputting audio signals; and
a processor connected to the audio input unit, the audio output unit, and the wireless transmission unit, wherein the processor acquires the user's said voice from the audio input unit, converts the voice into an audio stream data, and transmits the audio stream data to the mobile device by wireless transmission way, in order for the mobile device to transmit the audio stream data to the server system through a said communication network accessible to the mobile device, and to receive an audio stream data converted according to the first translation text or the second translation text acquired by the server system in order to be output in voice.

4. The simultaneous interpretation device of claim 3, wherein the wireless transmission unit is a Bluetooth module.

5. The simultaneous interpretation device of claim 4, wherein the wireless transmission unit comprises a command transmission module and an audio transmission module, and the processor transmits control instructions to the mobile device through the command transmission module via a command channel and receives the audio stream data from the mobile device through the audio transmission module via an audio streaming channel.

6. The simultaneous interpretation device of claim 5, wherein the command transmission module transmits control instructions to the mobile device through a Bluetooth Low Energy (BLE) channel or Serial Port Profile (SPP) channel, and the audio transmission module receives the audio stream data from the mobile device through an Advanced Audio Distribution Profile (A2DP) channel.

7. The simultaneous interpretation device of claim 3, further comprising a first language trigger unit and a second language trigger unit, wherein the processor transmits to the mobile device a recorded audio stream data as well as a first command corresponding to a first target language upon detecting activation of the first language trigger unit, and transmits to the mobile device a recorded audio stream data as well as a second command corresponding to a second target language upon detecting activation of the second language trigger unit, in order for the server to convert the recorded audio stream data into textual data in a corresponding one of the first target language and the second target language according to the corresponding one of the first target language and the second target language.

8. A simultaneous interpretation system, comprising:
a simultaneous interpretation device;
a mobile device connected to the simultaneous interpretation device by wireless transmission way; and
a server connected to the mobile device through a communication network;
wherein the simultaneous interpretation device transmits an audio stream data to the mobile device by wireless transmission way, the mobile device converts the audio stream data into textual data and transmits the textual data to the server through the communication network, the server translates the textual data according to a target language and text corpuses in an optimized database to acquire a first translation text, the server also transmits the textual data to a third-party database in order for the third-party database to translate the textual data and for the server to acquire a second translation text from the third-party database, and the server transmits the first translation text to the mobile device upon acquiring the first translation text, in order for the simultaneous interpretation device to output the first translation text in voice, or transmits the second translation text to the mobile device upon failure to acquire the first translation text, in order for the simultaneous interpretation device to output the second translation text in voice.

9. The simultaneous interpretation system of claim 8, wherein the server creates a correlated text corpus index entry and a translation text according to the textual data and the second translation text upon failure to acquire the first translation text, and storages the correlated text corpus index entry and the translation text into the optimized database.

10. The simultaneous interpretation system of claim 8, wherein, when disconnected from the server, the mobile device converts the audio stream data into the textual data according to an offline database downloaded and thereby established from the server by a user in advance, to translate the textual data according to text corpuses in the offline database that correspond to the target language and thereby acquire a third translation text, to convert the third translation text into an audio stream data, and to transmit the audio stream data to the simultaneous interpretation device in order for the simultaneous interpretation device to output the audio stream data in voice.

11. A simultaneous interpretation method, comprising the steps of:
acquiring an audio stream data input by a user into a simultaneous interpretation device;
converting the audio stream data into textual data according to a source language, after acquiring the audio stream data;
translating the textual data according to text corpuses in an optimized database that correspond to a target language in order to acquire a first translation text;
transmitting the textual data to a third-party database in order for the third-party database to translate the textual data according to the target language, and acquiring a second translation text from the third-party database; and
determining whether the first translation text is acquired; and if yes, converting the first translation text into an audio stream data and transmitting the audio stream data to the simultaneous interpretation device in order for the simultaneous interpretation device to output the audio stream data in voice; or if no, converting the second translation text into an audio stream data and transmitting the audio stream data to the simultaneous interpretation device in order for the simultaneous interpretation device to output the audio stream data in voice.

12. The simultaneous interpretation method of claim 11, wherein creating a correlated text corpus index entry and a translation text according to the textual data and the second translation text upon failure to acquire the first translation text, and storages the correlated text corpus index entry and the translation text into the optimized database.
